(19) United States
(12) Patent Application Publication
(10) Pub. No.: US 2016/0042110 A1
(43) Pub. Date: Feb. 11, 2016

(54) HIGH QUALITY PHYSICAL DESIGN FOR MONOLITHIC THREE-DIMENSIONAL INTEGRATED CIRCUITS (3D IC) USING TWO-DIMENSIONAL INTEGRATED CIRCUIT (2D IC) DESIGN TOOLS

(71) Applicant: QUALCOMM Incorporated, San Diego, CA (US)

(72) Inventors: Sung Kyu LIM, Atlanta, GA (US); Kambiz SAMADI, San Diego, CA (US); Pratyush KAMAL, San Diego, CA (US); Yang DU, Carlsbad, CA (US)

(21) Appl. No.: 14/638,323

(22) Filed: Mar. 4, 2015

Related U.S. Application Data
(60) Provisional application No. 62/035,467, filed on Aug. 10, 2014.

(51) Int. Cl. G06F 17/50

(52) U.S. Cl. CPC G06F 17/5072

(57) ABSTRACT

A method of designing a multi-tier three-dimensional integrated circuit (3D IC) is provided that allows the use of two-dimensional integrated circuit (2D IC) design tools. When a 2D IC design tool is used, a macro for each of the tiers indicating areas available and unavailable for placement of circuit elements in each tier is created, and the macros are superimposed on one another. Circuit elements to be implemented in the 3D IC, such as logic cells and interconnects, are shrunk and then placed and repopulated on the superimposed macro. The repopulated circuit elements on the superimposed macro are then partitioned into tiers. Monolithic inter-tier via (MIV) placement and tier-to-tier routing are designed to provide electrical connections between circuit elements in different tiers. Power, performance and area (PPA) optimization may also be performed to optimize the 3D IC layout.

### CLAIM OF PRIORITY UNDER 35 U.S.C. §119

The present Application for Patent claims priority to Provisional Application No. 62/035,467, entitled “HIGH QUALITY PHYSICAL DESIGN FOR MONOLITHIC THREE-DIMENSIONAL INTEGRATED CIRCUITS (3D IC) USING TWO-DIMENSIONAL INTEGRATED CIRCUIT (2D IC) DESIGN TOOLS,” filed Aug. 10, 2014, and assigned to the assignee hereof and hereby expressly incorporated by reference herein.

### FIELD OF DISCLOSURE

Various embodiments described herein relate to the design of three-dimensional integrated circuits (3D ICs), and more particularly, to the design of 3D ICs using two-dimensional integrated circuit (2D IC) design tools.

### BACKGROUND

Three-dimensional integrated circuits (3D ICs) are being designed and implemented for systems and devices with increasingly stringent form factor requirements, such as mobile smartphone devices. Various types of three-dimensional integration technologies have been devised for 3D IC fabrication, including through-silicon via (TSV) and silicon interposer technologies, for example. More recently, monolithic 3D IC technology has been emerging for advanced 3D IC fabrication by offering much higher integration densities than other 3D IC integration technologies such as TSV and silicon transposer, due to the advancement in fabrication technology utilizing nano-scale monolithic inter-tier vias (MIVs).

Various design styles may be used for designing monolithic 3D ICs, including transistor-level, gate-level and block-level design styles. The gate-level design style for designing monolithic 3D ICs may allow the designer to reuse existing standard cells with little or no overhead in terms of total silicon area. Moreover, a sufficiently high integration density with an associated reduction in power consumption may be achieved in monolithic 3D ICs by using the gate-level design style.

There is a need for integrated circuit design tools to allow a circuit designer to design monolithic 3D IC circuitry. However, because the monolithic 3D IC is a relatively new technology, delivery of commercial software tools for monolithic 3D IC design is expected to be delayed until the manufacturing process becomes reliable and profitable. Despite the lack of commercially available software tools for monolithic 3D IC design, chip designers and manufacturers may feel a pressing need to offer monolithic 3D IC chips for commercial adoption without waiting for commercially available 3D IC design tools tailored for monolithic 3D ICs.

### SUMMARY

Exemplary embodiments are directed to a method of designing three-dimensional integrated circuits (3D ICs), and more particularly, to a method of designing 3D ICs using two-dimensional integrated circuit (2D IC) design tools.

In an embodiment, a method of designing a three-dimensional integrated circuit having a plurality of tiers is provided, the method comprising: providing a plurality of macros for said plurality of tiers, each of the macros including an area available for placement of circuit elements and another area unavailable for placement of circuit elements in a respective one of said plurality of tiers; superimposing said plurality of macros to generate a superimposed macro including one or more areas available for placement of circuit elements in any of the tiers, one or more areas available for placement of circuit elements in one or more but not all of the tiers, and one or more areas unavailable for placement of circuit elements in any of the tiers; shrinking the circuit elements by a ratio based on the number of tiers to generate shrunk two-dimensional circuit elements; placing and routing the shrunk two-dimensional circuit elements on the superimposed macro; and partitioning the superimposed macro into said plurality of tiers.

### BRIEF DESCRIPTION OF THE DRAWINGS

The accompanying drawings are presented to aid in the description of embodiments and are provided solely for illustration of the embodiments and not limitations thereof.

FIGS. 1A and 1B illustrate examples of macro placements in Tier 1 and Tier 2, respectively, before superimposition.

FIG. 1C illustrate an example of superimposed macro placements of Tier 1 and Tier 2.

FIG. 2A illustrate an example of an area in the superimposed macro of FIG. 1C that is fully available for placement of circuit elements in either or both of Tier 1 and Tier 2.

FIG. 2B illustrates an example of areas in the superimposed macro of FIG. 1C that are partially available for placement of circuit elements in either Tier 1 or Tier 2 but not both tiers.

FIG. 2C illustrates an example of areas in the superimposed macro of FIG. 1C that are not available for placement in either tier.

FIG. 3A illustrates two-dimensional placement of shrunk 2D circuit elements on the superimposed macro as illustrated in FIGS. 2A-2C.

FIG. 3B illustrates repopulated circuit elements on the superimposed macro showing that the cells are overlapping after repopulation.

FIGS. 3C and 3D illustrate placements of circuit elements in Tier 1 and Tier 2, respectively, showing that cell overlap is removed after tier partitioning.

FIG. 4A illustrates a screen shot of an example of a shrunk two-dimensional layout.

FIG. 4B illustrates overlapped screen shots of Tier 1 and Tier 2 layouts after partitioning.

FIG. 5 is a flowchart illustrating an embodiment of a method of designing a three-dimensional integrated circuit having a plurality of tiers using a two-dimensional design tool for two-dimensional integrated circuits.

FIG. 6 is a simplified diagram illustrating an embodiment of a computer in which the method according to embodiments of the disclosure may be implemented.

### DETAILED DESCRIPTION

Aspects of the disclosure are described in the following description and related drawings directed to specific embodiments. Alternate embodiments may be devised without departing from the scope of the disclosure. Additionally, well known elements will not be described in detail or will be omitted so as not to obscure the relevant details of the disclosure.

The word “exemplary” is used herein to mean “serving as an example, instance, or illustration.” Any embodiment described herein as “exemplary” is not necessarily to be construed as preferred or advantageous over other embodiments. Likewise, the term “embodiments” does not require that all embodiments include the discussed feature, advantage or mode of operation.

The terminology used herein is for the purpose of describing particular embodiments only and is not intended to be limiting of the embodiments. As used herein, the singular forms “a,” “an,” and “the,” are intended to include the plural forms as well, unless the context clearly indicates otherwise. It will be further understood that the terms “comprises,” “comprising,” “includes,” or “including,” when used herein, specify the presence of stated features, integers, steps, operations, elements, or components, but do not preclude the presence or addition of one or more other features, integers, steps, operations, elements, components, or groups thereof. Moreover, it is understood that the word “or” has the same meaning as the Boolean operator “OR,” that is, it encompasses the possibilities of “either” and “both” and is not limited to “exclusive or” (“XOR”), unless expressly indicated otherwise.

Embodiments of the disclosure relate to a method of designing monolithic 3D ICs, and more particularly, to a method of designing monolithic 3D ICs using the gate-level design style, by utilizing existing computer aided design (CAD) software tools for two-dimensional integrated circuits (2D ICs). Various implementations of the method may be made without departing from the scope of the disclosure. For example, if a supplier of 2D IC CAD software makes its source code available, modifications may be made to the source code to allow the circuit designer to run a modified CAD application based on the modified source code to design monolithic 3D ICs. On the other hand, if the source code of the 2D IC CAD software is not available, the circuit designer may utilize an application programming interface (API), if available, to implement the method of designing monolithic 3D ICs within the scope of the disclosure. Alternatively, the method according to embodiments of the disclosure may be performed while running the 2D IC CAD software, where some of the steps may be performed manually or by running other design tools, for example, tools for tier-to-tier partitioning, monolithic inter-tier via (MIV) planning, or tier-to-tier routing.

In an embodiment, a method according to an embodiment of the disclosure includes shrinking the dimensions of circuit elements, such as logic cells, interconnects or other elements, by a ratio that is dependent on the number of tiers available. Such a technique may be called “shrunk 2D.” First, the physical dimensions of the circuit elements including their interconnects are shrunk. After the dimensions of the circuit elements are shrunk, two-dimensional physical design of the circuit, including the placement, routing, and timing closure of the circuit elements, for example, may be performed by placing these shrunk cells onto a chip footprint that is reduced by the same ratio. If, for example, a monolithic 3D IC includes two tiers of dies on which cells may be placed, the area of each cell may be shrunk by half. In an embodiment, the length and width of each cell may be shrunk proportionally. If the monolithic 3D IC includes two tiers of dies, for example, the length and width of each cell may be shrunk by a ratio of approximately 0.707.

Two-dimensional physical design of the circuit may be performed by a commercially available physical design tool for 2D ICs. However, the resistance-capacitance (RC) parameters of the circuit elements, for example, the RC parameters of logic cells, interconnects or other elements, are not shrunk or scaled at this point because the shrunk 2D layout will later be transformed into a 3D layout, and layout optimization will be performed to target the final 3D layout, not the intermediate shrunk 2D layout.

After the intermediate shrunk 2D layout is designed, the cells are partitioned into tiers. After tier-by-tier partitioning, the locations of monolithic inter-tier vias (MIVs) for tier-to-tier connections and die-by-die routing are determined In an embodiment, tier partitioning may be performed by using a commercially available circuit partitioner software tool. Subsequently, die-by-die layout touchups are performed to fix any minor placement perturbation problems introduced by tier-to-tier partitioning. In an embodiment, die-by-die layout touchups may be performed by using commercially available placement legalizer and detailed router software tools.

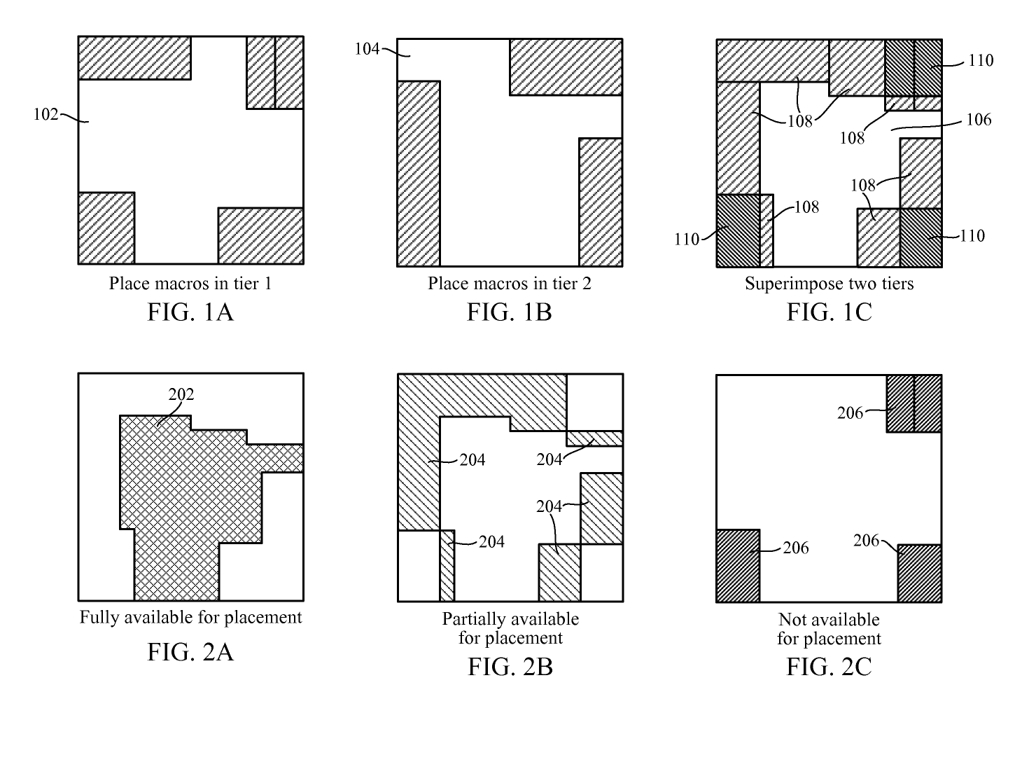

In an embodiment, macros for superimposed tiers of logic cells are created before the cells are shrunk by a ratio that is dependent on the number of tiers of logic cells. In an embodiment, macros are created and placement regions are determined for each of the tiers in a software application such as a commercially available 2D IC CAD software application. In an embodiment, the macros are not shrunk while running the software application. An example of placing two tiers of macros for two tiers of logic cells is illustrated in FIGS. 1A-1C. The macro for Tier 1, which is the first tier of the circuitry, is placed on a two-dimensional plane, with an area available for cell placement in Tier 1 shown as the white area 102 in FIG. 1A, and the macro for Tier 2, which is the second tier of the circuitry, is placed on another two-dimensional plane, with an area available for cell placement in Tier 2 shown as the white area 104 in FIG. 1B. The macros for Tier 2 and Tier 1 are then superimposed to generate a superimposed macro, with a white area 106 which is fully available for cell placement in both Tier 1 and Tier 2, shaded areas 108 which are partially available for cell placement in either Tier 1 or Tier 2 but not both tiers, and shaded areas 110 which are not available for cell placement in either Tier 1 or Tier 2, as shown in FIG. 1C.

FIGS. 2A-2C illustrate areas that are fully available, partially available and not available for cell placement, respectively, based on the superimposition of the macros for Tier 1 and Tier 2 as illustrated in FIG. 1C. FIG. 2A shows a shaded area 202 that is fully available for cell placement in both Tier 1 and Tier 2, whereas FIG. 2B shows shaded areas 204 that are partially available for cell placement in either Tier 1 or Tier 2 but not both tiers. FIG. 2C shows shaded areas 206 that are not available for cell placement in either Tier 1 or Tier 2.

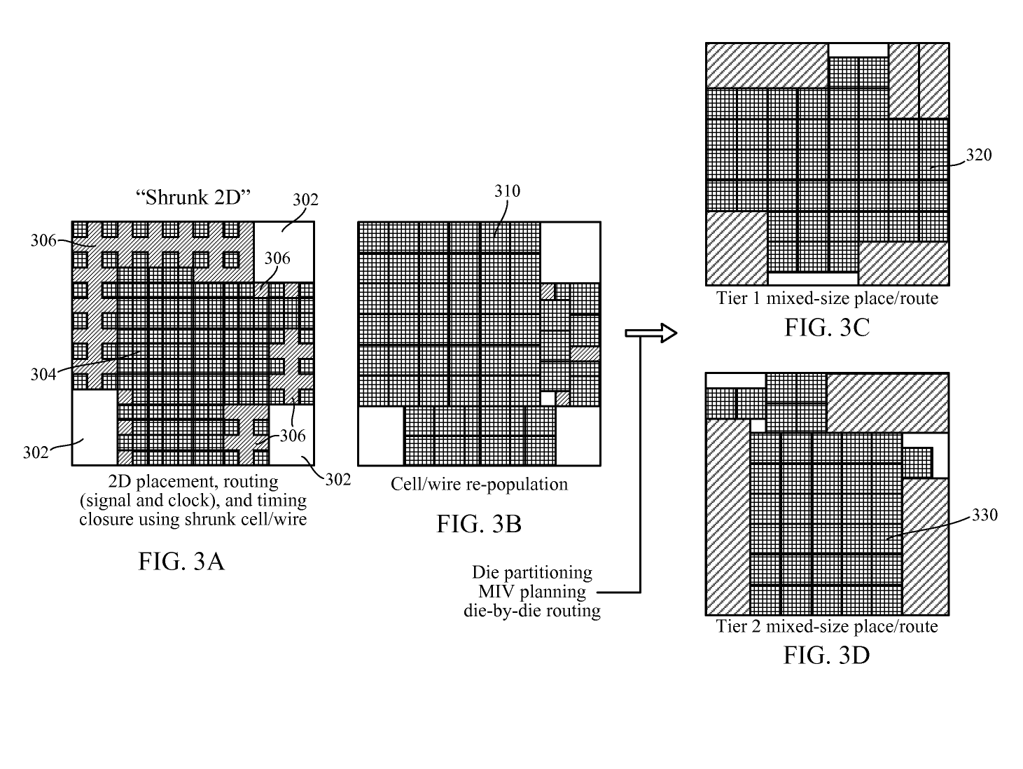

After the macro for the superimposed tiers is created as illustrated in FIGS. 1A-1C and 2A-2C, the dimensions of circuit elements, such as logic cells, interconnects or other elements, are shrunk by a ratio that depends on the number of tiers. In an embodiment, the resistance-capacitance (RC) parameters of circuit elements such as logic cells or interconnects are not shrunk or otherwise scaled, however. FIGS. 3A-3D illustrate examples of two-dimensional placement of shrunk 2D circuit elements onto the superimposed macro, repopulation of circuit elements on the superimposed macro, and tier placement, routing and partitioning. FIG. 3A illustrates two-dimensional placement of shrunk 2D circuit elements on the superimposed macro as illustrated in FIGS. 2A-2C. The white areas 302 in FIG. 3A correspond to the shaded areas 206 of FIG. 2C, indicating regions in which the shrunk 2D circuit elements are prohibited from being placed in either Tier 1 or Tier 2. In FIG. 3A, the dark shaded blocks 304 indicate regions in which the shrunk 2D circuit elements on either or both of Tier 1 and Tier 2 can be placed, whereas alternating patterns of light and dark shaded blocks 306 indicate regions in which the shrunk 2D circuit elements on either Tier 1 or Tier 2 but not both can be placed. In an embodiment, in addition to the physical placement of the shrunk 2D circuit elements onto the superimposed macro, signal routing, clock routing, and timing closure are performed.

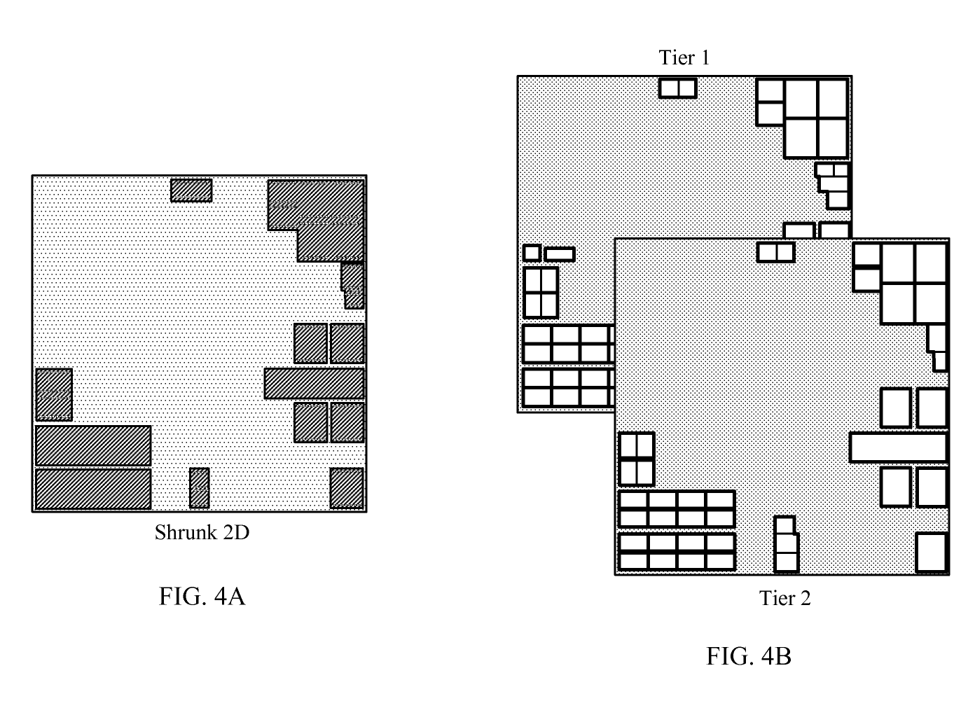

FIG. 3B illustrates repopulated circuit elements, such as logic cells, interconnects or other elements, contained in larger shaded blocks 310 on the superimposed macro, showing that the cells are overlapping after repopulation. Repopulation of the circuit elements may be performed by a 2D IC CAD software tool in a conventional manner. In an embodiment, die partitioning or tier-by-tier partitioning may also be performed by a commercially available partitioner software tool in a conventional manner. Cells are now overlapping with each other after the repopulation. In a further embodiment, the locations of MIVs and die-by-die routing may be planned by using a commercially available 2D IC router software tool in a conventional manner. Die partitioning results in a separate layout for each tier. For example, in the example shown in FIGS. 3A-3D, partitioning of a two-tier 3D IC results in a Tier 1 layout as illustrated in FIG. 3C and a Tier 2 layout as illustrated in FIG. 3D, showing that cell overlap is removed after partitioning. The shaded blocks 320 in FIG. 3C indicate areas in which circuit elements in Tier 1 may be placed, whereas the shaded blocks 330 in FIG. 3D indicate areas in which circuit elements in Tier 2 may be placed. In an embodiment, the Tier 1 and Tier 2 layouts may include placement and routing of mixed-size cells or interconnects. FIG. 4A shows an example of a screen shot of a shrunk 2D layout, whereas FIG. 4B shows an example of overlapping screen shots of Tier 1 and Tier 2 layouts illustrating that the cell overlaps are removed after tier partitioning.

In a further embodiment, the partitioned circuit elements such as logic cells, interconnects or other elements in each of the tiers may be optimized for power, performance and area (PPA). In an embodiment, the RC parameters of the circuit elements, which are not scaled while the dimensions of the circuit elements are shrunk, may be used in the optimization of the 3D layout comprising the partitioned tiers of circuit elements with associated tier-to-tier MIVs and electrical routing. Moreover, die-by-die layout touchups may be performed to eliminate or reduce minor placement perturbation errors introduced during partitioning. Although the embodiments described above with respect to FIGS. 1A-1C, 2A-2C, 3A-3D and 4A-4B relate to the design of a 3D IC having two tiers of dies, the principle also applies to 3D ICs having three or more tiers of dies on which circuit elements may be placed.

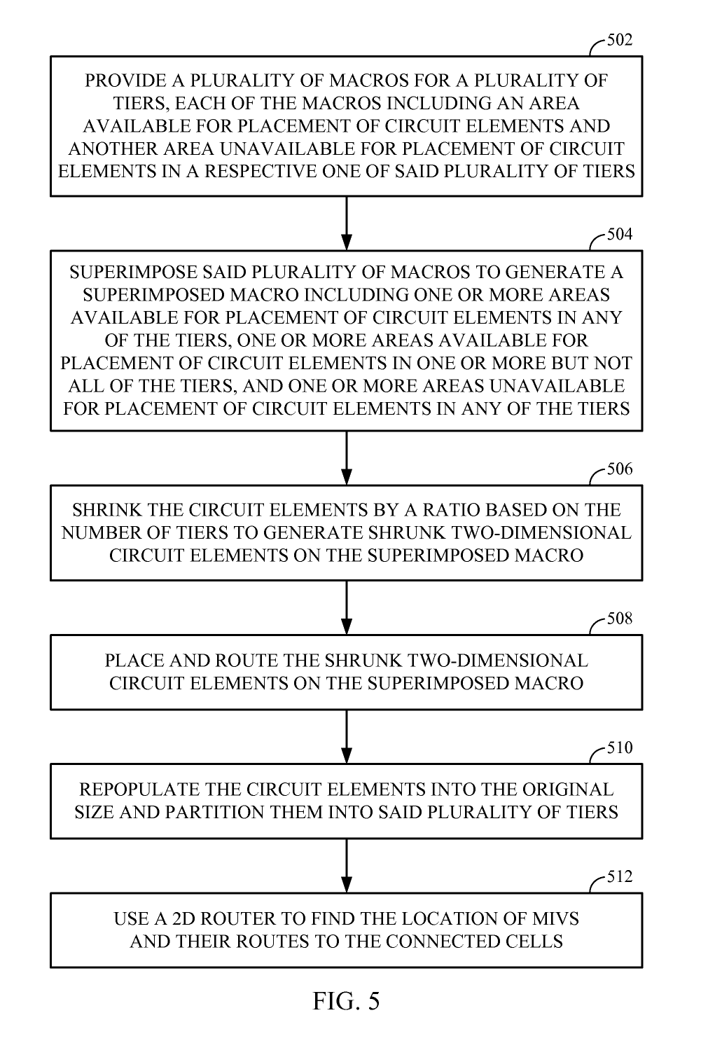

FIG. 5 is a flowchart illustrating an embodiment of a method of designing a 3D IC having a plurality of tiers using a two-dimensional computer-aided design (CAD) tool for 2D ICs. In FIG. 5, a plurality of macros are initially provided for a plurality of tiers, respectively, in step 502. In an embodiment, each of the macros includes an area available for the placement of circuit elements and another area unavailable for the placement of circuit elements in the respective tier. The macros for the multiple tiers of integrated circuits are then superimposed to generate a superimposed macro in step 504. In an embodiment, the superimposed macro includes one or more areas available for the placement of circuit elements in any of the tiers, one or more areas available for the placement of circuit elements in one or more but not all of the tiers, and one or more areas unavailable for the placement of circuit elements in any of the tiers.

In an embodiment, the circuit elements are shrunk by a ratio based on the number of tiers to generate shrunk two-dimensional circuit elements in step 506. For example, if a monolithic 3D IC includes two tiers of integrated circuit dies on which circuit elements may be placed, the area of each circuit element may be shrunk by half. In an embodiment, the length and width of each circuit element are shrunk proportionally. For example, in a 3D IC with two tiers of dies, the length and width of each circuit element may be shrunk by a ratio of approximately 0.707. Likewise, for 3D ICs with multiple tiers, the area of each circuit element may be shrunk by a ratio based on the number of tiers, and the length and width of each circuit element may be shrunk proportionally.

In an embodiment, the dimensions of interconnects as well as the dimensions of transistors, logic cells, or other types of digital or analog circuit elements are shrunk proportionally even though the RC parameters of the circuit elements remain constant. In an embodiment in which a memory is placed with other types of logic cells or circuit elements, the memory may be preplaced on the macro for a given tier, and the preplaced memory may be regarded as a combination of its pins which may serve as anchors to prevent other types of cells in other tiers from being placed over them. In an embodiment, memories may be preplaced on more than one tier. The footprint of the memory itself may be shrunk for two-dimensional layout planning while the relative locations of its pins are not scaled. After the two-dimensional circuit elements are shrunk, they are placed and routed on the superimposed macro in step 508. The circuit elements are then repopulated into their original sizes and partitioned into the plurality of tiers in step 510. In a further embodiment, a two-dimensional (2D) router is used to find the location of the monolithic inter-tier vias (MIVs) and their routes to the connected cells in step 512.

The method according to embodiments of the disclosure may be implemented in various existing CAD software tools for designing 2D ICs, including existing commercially available placer, router and PPA optimizer software tools. Moreover, for tier-by-tier partitioning, placement of monolithic inter-tier vias (MIVs), and tier-to-tier routing, commercially available MIV planner and tier partitioner software tools may be used. If an API is provided in CAD software for 2D IC design, the method according to embodiments of the disclosure may be implemented by modifying the application to perform the process steps described above. If the source code for the CAD software for 2D IC design is available, the source code itself may be modified to implement the process steps described above. Alternatively, some of the process steps may be performed manually or by one or more separate design tools whereas the shrunk 2D layout for each tier may be designed on commercially available 2D IC CAD software.

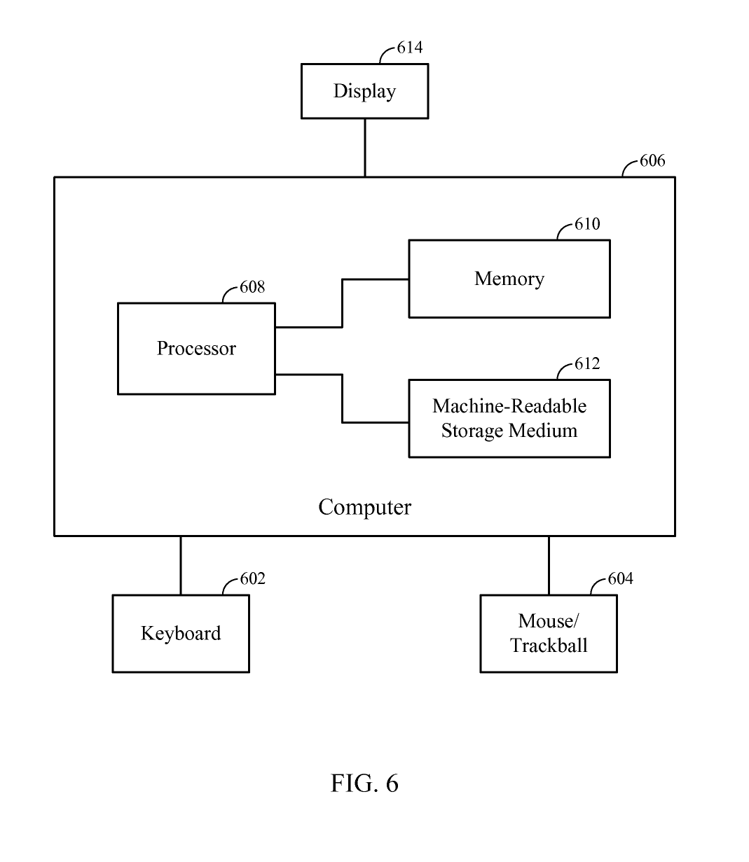

FIG. 6 is a simplified diagram illustrating an example of a computer for performing the method of designing a 3D IC using one or more 2D IC design tools according to embodiments of the disclosure. In FIG. 6, a keyboard 602 and a mouse or trackball 604 may be provided to allow a circuit designer to enter information and to manipulate images or circuit layouts. A computer 606 having a processor 608, a memory 610 and a machine-readable storage medium 612 may be provided to execute instructions in the 2D IC design tool as well as instructions in one or more applications for partitioning tiers and superimposing macros, for example. A display 614 may also be provided to display the 2D IC layout for each tier of integrated circuits as well as superimposed tiers of integrated circuits, for example. In an embodiment, the instructions for performing the process steps according to embodiments of the disclosure may be stored in the machine-readable storage medium 612 for execution by the processor 608. In an embodiment, such instructions may be loaded to the memory 610 from the machine-readable storage medium 612 before execution by the processor 608, for example. Such a computer may be a mainframe, a dedicated CAD station, a desktop computer, a laptop computer, a pad, or a mobile device, for example. Alternatively, such a computer may be a distributed computing network in which instructions may be executed by more than one processor. Moreover, instead of storing all the instructions in a single storage medium, different portions of the instructions may be stored in different storage media at different locations. For example, the instructions may be stored in a cloud network.

While the foregoing disclosure describes illustrative embodiments, it should be noted that various changes and modifications could be made herein without departing from the scope of the appended claims. The functions, steps or actions in the method and apparatus claims in accordance with the embodiments described herein need not be performed in any particular order unless explicitly stated otherwise. Furthermore, although elements may be described or claimed in the singular, the plural is contemplated unless limitation to the singular is explicitly stated.

What is claimed is:

1. A method of designing a three-dimensional integrated circuit having a plurality of tiers, comprising:
providing a plurality of macros for said plurality of tiers, each of the macros including an area available for placement of circuit elements and another area unavailable for placement of circuit elements in a respective one of said plurality of tiers;
superimposing said plurality of macros to generate a superimposed macro including one or more areas available for placement of circuit elements in any of the tiers, one or more areas available for placement of circuit elements in one or more but not all of the tiers, and one or more areas unavailable for placement of circuit elements in any of the tiers;
shrinking the circuit elements by a ratio based on the number of tiers to generate shrunk two-dimensional circuit elements;
placing the shrunk two-dimensional circuit elements on the superimposed macro; and
partitioning the superimposed macro into said plurality of tiers.

2. The method of claim 1, further comprising planning a plurality of monolithic inter-tier vias (MIVs) for electrical connections between two or more of said plurality of tiers.

3. The method of claim 2, further comprising routing the electrical connections between two or more of said plurality of tiers.

4. The method of claim 1, wherein the circuit elements comprise logic cells.

5. The method of claim 1, wherein the circuit elements comprise interconnects.

6. The method of claim 1, further comprising repopulating the shrunk two-dimensional circuit elements on the superimposed macro to generate repopulated circuit elements.

7. The method of claim 6, further comprising optimizing the repopulated circuit elements for power, performance and area.

8. The method of claim 6, wherein the repopulated circuit elements in one or more of said plurality of tiers include mixed-size circuit elements.

9. The method of claim 6, further comprising maintaining resistance-capacitance (RC) parameters of the circuit elements before they are shrunk and repopulated.

10. The method of claim 9, further comprising optimizing the repopulated circuit elements based at least in part on the RC parameters.

11. An apparatus for designing a three-dimensional integrated circuit having a plurality of tiers, comprising:
means for providing a plurality of macros for said plurality of tiers, each of the macros including an area available for placement of circuit elements and another area unavailable for placement of circuit elements in a respective one of said plurality of tiers;
means for superimposing said plurality of macros to generate a superimposed macro including one or more areas available for placement of circuit elements in any of the tiers, one or more areas available for placement of circuit elements in one or more but not all of the tiers, and one or more areas unavailable for placement of circuit elements in any of the tiers;
means for shrinking the circuit elements by a ratio based on the number of tiers to generate shrunk two-dimensional circuit elements;
means for placing and routing the shrunk two-dimensional circuit elements on the superimposed macro; and
means for partitioning the superimposed macro into said plurality of tiers.

12. The apparatus of claim 11, further comprising means for planning a plurality of monolithic inter-tier vias (MIVs) for electrical connections between two or more of said plurality of tiers.

13. The apparatus of claim 12, further comprising means for routing the electrical connections between two or more of said plurality of tiers.

14. The apparatus of claim 11, further comprising means for repopulating the shrunk two-dimensional circuit elements on the superimposed macro to generate repopulated circuit elements.

15. The apparatus of claim 14, further comprising means for maintaining resistance-capacitance (RC) parameters of the circuit elements before they are shrunk and repopulated.

16. A non-transitory machine-readable storage medium encoded with instructions executable to design a three-dimensional integrated circuit having a plurality of tiers, the instructions comprising instructions to:
provide a plurality of macros for said plurality of tiers, each of the macros including an area available for placement of circuit elements and another area unavailable for placement of circuit elements in a respective one of said plurality of tiers;
superimpose said plurality of macros to generate a superimposed macro including one or more areas available for placement of circuit elements in any of the tiers, one or more areas available for placement of circuit elements in one or more but not all of the tiers, and one or more areas unavailable for placement of circuit elements in any of the tiers;
shrink the circuit elements by a ratio based on the number of tiers to generate shrunk two-dimensional circuit elements;
place the shrunk two-dimensional circuit elements on the superimposed macro; and
partition the superimposed macro into said plurality of tiers.

17. The non-transitory machine-readable storage medium of claim 16, wherein the instructions further comprise instructions to plan a plurality of monolithic inter-tier vias (MIVs) for electrical connections between two or more of said plurality of tiers.

18. The non-transitory machine-readable storage medium of claim 16, wherein the instructions further comprise instructions to route the electrical connections between two or more of said plurality of tiers.

19. The non-transitory machine-readable storage medium of claim 16, wherein the instructions further comprise instructions to repopulate the shrunk two-dimensional circuit elements on the superimposed macro to generate repopulated circuit elements.

20. The non-transitory machine-readable storage medium of claim 19, wherein the instructions further comprise instructions to maintain resistance-capacitance (RC) parameters of the circuit elements before they are shrunk and repopulated.
